(19) United States
(12) Patent Application Publication
(10) Pub. No.: US 2022/0029530 A1
(43) Pub. Date: Jan. 27, 2022

(54) DIRECT CURRENT (DC) BUS ELECTROMAGNETIC INTERFERENCE (EMI) FILTERING FOR POWER ADAPTERS

(71) Applicant: Google LLC, Mountain View, CA (US)

(72) Inventors: Yiming Li, Gainesville, FL (US); Shuo Wang, Gainesville, FL (US); Honggang Sheng, Milpitas, CA (US); Douglas Osterhout, San Jose, CA (US); Srikanth Lakshmikanthan, Milpitas, CA (US)

(21) Appl. No.: 17/296,882

(22) PCT Filed: Mar. 26, 2020
(86) PCT No.: PCT/US2020/024902

§ 371 Date: May 25, 2021

Related U.S. Application Data
(60) Provisional application No. 62/824,085, filed on Mar. 26, 2019.

(51) Int. Cl. H02M 1/44; H02M 3/335

(52) U.S. Cl. CPC H02M 1/44; H02M 3/335

(57) ABSTRACT

An example power adapter includes a rectifier configured to convert an input alternating current (AC) power signal on an AC bus into an input direct current (DC) power signal on an input DC bus; a split differential mode (DM) choke connected to the input DC bus, wherein the split DM choke comprises a first DM choke on a high side of the input DC bus and a second DM choke on a low side of the input DC bus; and a switched mode power converter configured to output, using the input DC power signal, an output DC power signal on an output DC bus.

### BACKGROUND

Power adapters may provide electrical power to facilitate the operation of electronic devices and/or recharging of batteries of electronic devices. For instance, a power adapter may be connected to an alternating current (AC) mains power signal (e.g., a 120 volt or 240 volt socket) and generate a direct current (DC) power signal that is provided to an electronic device.

### SUMMARY

In general, aspects of this disclosure are directed to power adapters with electromagnetic interference (EMI) filters. A power adapter may include a rectifier, such as a diode bridge, that converts (e.g., rectifies) an AC power signal into a DC power signal. The AC power signal provided to the rectifier may contain various types of EMI, such as common mode (CM) noise and differential mode (DM) noise. As such, some power adapters include EMI filter components on an AC side of the rectifier. These EMI filter components may have to be fairly large in size (e.g., volume) in order to tolerate operation. Including large EMI filter components may increase the overall size the power adapter, which may not be desirable. For instance, large power adapters may require pigtail connectors or may block other outlets.

In accordance with one or more techniques of this disclosure, a power adapter may include EMI filter components positioned on a DC side of a rectifier. For instance, a power adapter may include one or more DM filtering components and/or one or more CM filtering components on a DC side of a rectifier. By positioning the EMI filter components on the DC side of the rectifier, smaller sized components may be used while still achieving similar EMI filtration performance. In this way, aspects of this disclosure may enable a reduction in the size of power adapters.

As one example, a power adapter includes a rectifier configured to convert an input alternating current (AC) power signal on an AC bus into an input direct current (DC) power signal on an input DC bus; a split differential mode (DM) choke connected to the input DC bus, wherein the split DM choke comprises a first DM choke on a high side of the input DC bus and a second DM choke on a low side of the input DC bus; and a switched mode power converter configured to output, using the input DC power signal, an output DC power signal on an output DC bus.

As another example, a method includes converting, by a rectifier, an input AC power signal on an AC bus into an input DC power signal on an input DC bus; filtering, by a split DM choke connected to the input DC bus, differential mode noise on the input DC bus, wherein the split DM choke comprises a first DM choke on a high side of the input DC bus and a second DM choke on a low side of the input DC bus; and generating, by a switched mode power converter and using the input DC power signal, an output DC power signal for output on an output DC bus.

As another example, a system includes a power adapter comprising: a rectifier configured to convert an input AC power signal on an AC bus into an input DC power signal on an input DC bus; a split DM choke connected to the input DC bus, wherein the split DM choke comprises a first DM choke on a high side of the input DC bus and a second DM choke on a low side of the input DC bus; and a switched mode power converter configured to output, using the input DC power signal, an output DC power signal on an output DC bus; and a computing device configured to receive the output DC power signal via the output DC bus.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating a power adapter that includes one or more EMI filter components, in accordance with one or more aspects of this disclosure.

FIG. 2 is a block diagram illustrating a power adapter that includes one or more EMI filter components, in accordance with one or more aspects of this disclosure.

FIGS. 3A and 3B are graphs illustrating currents flowing through power adapters, in accordance with one or more aspects of this disclosure.

FIG. 4 is a block diagram illustrating a power adapter that includes one or more EMI filter components, in accordance with one or more aspects of this disclosure.

FIG. 5 is a block diagram illustrating a power adapter that includes one or more EMI filter components, in accordance with one or more aspects of this disclosure.

FIGS. 6-8 are block diagrams illustrating example power adapters that includes one or more EMI filter components along with one or more cancelation capacitors, in accordance with one or more aspects of this disclosure.

FIG. 9 is a flowchart illustrating example operations of a power adapter, in accordance with one or more aspects of this disclosure.

### DETAILED DESCRIPTION

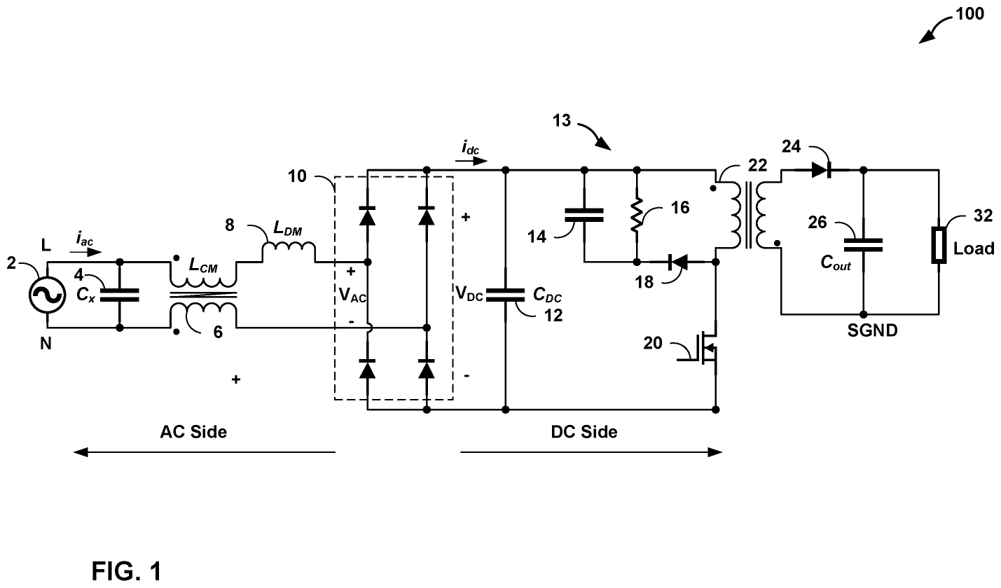

FIG. 1 is a block diagram illustrating a power adapter that includes one or more EMI filter components. As shown in FIG. 1, power adapter 100 includes alternating current (AC) source 2, capacitor 4, common mode (CM) filter component 6, differential mode (DM) filter component 8, rectifier 10, capacitor 12, power converter 13, capacitor 28, and load 32.

AC source 2 may represent any source of AC electrical energy that provides an AC power signal to power adapter 100. For instance, AC source 2 may represent connectors of power adapter 100 that are configured to plug in to a mains power receptacle (e.g., a household power outlet). In some examples, the connectors of AC source 2 may be removable from power adapter 100 (e.g., to facilitate swapping out to accommodate different plug styles).

Capacitor 4 may represent an x-capacitor in that capacitor 4 is connected across AC source 2 (e.g., across the line “L” and neutral “N” signals). Capacitor 4 may be a film capacitor and may be sized to handle standard input voltages (e.g., 120 volts, 240 volts, etc.).

CM filter component 6 may be configured to filter out or otherwise suppress CM noise from the AC power signal provided by AC source 2. CM filter component 6 may include a CM choke L_{CM}. For instance, CM filter component 6 may include two coils wound on a single core. As shown in FIG. 1, CM filter component 6 may be located on the AC side of rectifier 10.

DM filter component 8 may be configured to filter out or otherwise suppress DM noise from the AC power signal provided by AC source 2. In some examples, DM filter component 8 may include an inductor L_{DM}. In some examples, DM filter component 8 may be a leakage inductance of CM filter component 6 (e.g., the leakage inductance of L_{CM}). As shown in FIG. 1, DM filter component 8 may be located on the AC side of rectifier 10.

Rectifier 10 may be configured to convert an input alternating current (AC) power signal on an AC bus into an input direct current (DC) power signal on an input DC bus. For instance, as shown in FIG. 1, rectifier 10 may convert AC power signal V_{AC} into DC power signal V_{DC}. Rectifier 10 may include any suitable component capable of converting AC to DC. For instance, rectifier 10 may include a bridge (e.g., half or full) of diodes. Rectifier 10 may have an AC side and a DC side. The AC side of rectifier 10 is connected to an AC bus while the DC side of rectifier 10 is connected to a DC bus.

Capacitor 12 may represent a capacitor positioned on the outputs of rectifier 10. As such, capacitor 12 (C_{DC}) may operate as reservoir capacitor/bulk capacitor that smooths out the rectified power signal provided by rectifier 10.

Power adapter 100 may include power converter 13, which may be configured to output a DC power signal for use by a load, such as load 32. Power converter 13 may be any type of switched mode power converter (e.g., DC to DC power converter). As shown in the example of FIG. 1, power converter 13 may be a flyback power converter than includes capacitor 14, resistor 16, diode 18, switch 20 (e.g., a MOSFET), transformer 22, diode 24, and capacitor 26. However, power converter 13 may alternatively be a buck, boost, buck-boost, cuk, or any other type of DC/DC power converter. Power converter 13 may receive power an input DC power signal from an input DC bus and output a DC power signal on an output DC bus. As shown in FIG. 1, the low side of the output DC bus may be referred to as signal ground (SGND).

Load 32 may represent any consumer of DC electrical energy. For instance, load 32 may represent connectors of power adapter 100 (e.g., a load connector such as a plug, socket, etc.) that are configured to connect to an electronic device (or an intermediate cable that then connects to the electronic device). As one specific example, load 32 may represent a universal serial bus (USB) receptacle, such as a USB type-C connector.

As discussed above and as shown in FIG. 1, both CM filter component 6 and DM filter component 8 are located on the AC side of rectifier 10 of power adapter 100. As the input current (i_{ac}) may have a high peak value due to the operation of rectifier 10 (e.g., a diode bridge) a large size magnetic core may need to be used for CM filter component 6 to avoid saturation. Additionally, capacitor 4 (e.g., the X capacitor) may also have a large size. The large sizes of the magnetic core, and thus CM filter component 6, and capacitor 4 may result in an overall larger size of power adapter 100. Larger size power adapter may be undesirable as they may block other outlets, require pigtail connectors, and/or otherwise be bulky.

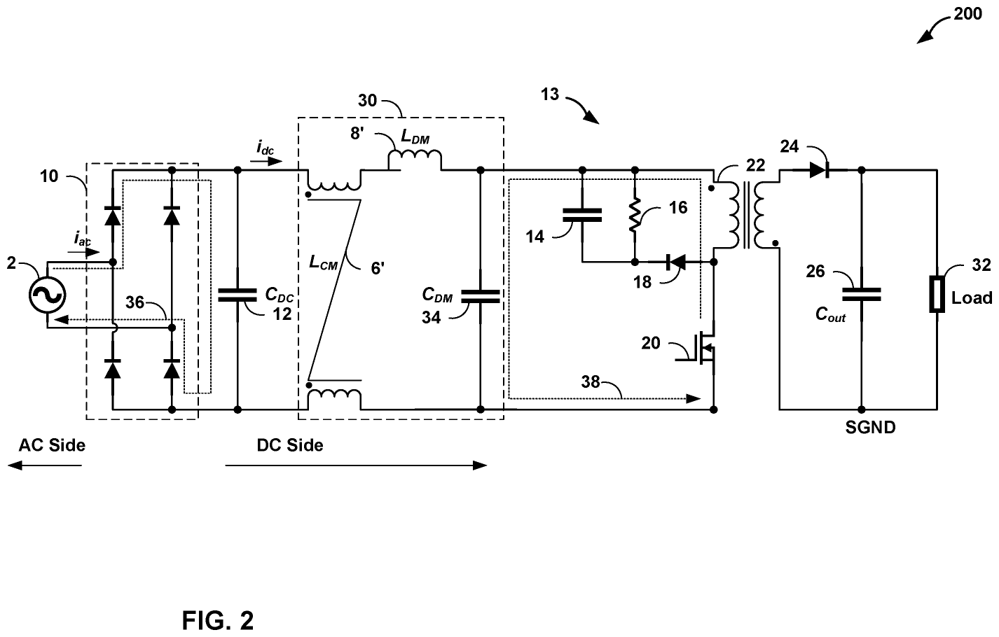

In accordance with one or more aspects of this disclosure, one or more EMI filter components (e.g., one or more of CM filter component 6 and DM filter component 8) may be moved to the DC side of rectifier 10. As one example, as opposed including a CM choke connected to both the high side and the low side of the AC bus, such as shown in FIG. 1, CM filter component 6 may include a CM choke connected to both the high side and the low side of the DC bus, such as shown in FIG. 2. As another example, as opposed to including an inductor on the high side of the AC bus, such as shown in FIG. 1, DM filter component 8 may include an inductor on the high side of the DC bus, such as shown in FIG. 2. As another example, as opposed to including an X capacitor across the high and low sides of the AC bus, such as capacitor 4 in FIG. 1, a power adapter may include a capacitor across the high and low sides of the DC bus, such as capacitor 34 in FIG. 2.

Moving one or more components to the DC side of rectifier 10 may present one or more advantages. As one example, as discussed in further detail below, the size (e.g., volume) of a core of a CM choke on the DC side may be smaller than the size of a core of a choke on the AC side. As another example, a smaller size (e.g., volume) capacitor may be used for the capacitor across the high and low sides of the DC bus as opposed to the capacitor across the high and low sides of the AC bus. In this way, the techniques of this disclosure enable the use of smaller components, which may enable a reduction in size of power adapters. By reducing the size of the power adapter, the techniques of this disclosure may enable relatively small power adapters to provide greater amounts of power. For instance, as opposed to only being able to power a mobile phone (e.g., 15 watts) a power adapter of two square inches may be able to power a laptop (e.g., 60 watts).

FIG. 2 is a block diagram illustrating a power adapter that includes one or more EMI filter components, in accordance with one or more aspects of this disclosure. AC source 2, rectifier 10, capacitor 12, power converter 13, capacitor 28, and load 32 of power adapter 200 may be configured to perform operations similar to AC source 2, rectifier 10, capacitor 12, power converter 13, capacitor 28, and load 32 of power adapter 100 of FIG. 1.

In contrast to power adapter 100 of FIG. 1, power adapter 200 of FIG. 2 includes common mode (CM) and differential mode (DM) electromagnetic interference (EMI) filter components 30 on a direct current (DC) side of rectifier 10. For instance, as shown in FIG. 2, filter components 30 include CM filter component 6′, which is connected across the high and low sides of the DC bus, and DM filter component 8′, which is on the high side of the DC bus.

As also shown in FIG. 2, power adapter 200 include capacitor 34 (CDM), which may be a DM noise filtering component. The capacitance of capacitor 34 may be much smaller (e.g., an order of magnitude less) than the capacitance of capacitor 12.

FIG. 2 further illustrates paths 36 and 38. Path 36 may represent the path for line frequency current ripple (e.g., in the power grid as represented by AC source 2). Path 38 may represent the path for switch frequency current ripple generate by switching (e.g., of switch 20). As shown by path 36, the current ripple from the AC side will mainly flow through capacitor 12 (e.g., because the capacitance of capacitor 34 is much smaller than the capacitance of capacitor 12). As shown by path 38, the switching current ripple (e.g., ripple induced by switch 20) will mainly flow through capacitor 34 (e.g., because the inductor of DM filter component 8 may have a relatively high impedance compared with the impedance of capacitor 34). For instance, capacitor 34 may suppress with high frequency noise caused by switch 20 while capacitor 12 may suppress low frequency noise caused by switch 20.

As a result of paths 36 and 38, the current flowing through the inductors of CM filter component 6 and DM filter component 8 is almost a constant DC component with small peak and RMS values. Due to the current (i.e., i_{dc}) being almost a constant DC component with small peak and RMS values, the core of CM filter component 6 is less likely to become saturated and the winding loss of the filter chokes (e.g., of CM filter component 6′) may be greatly reduced. In this way, the sizes of the cores of the chokes of CM filter component 6′ and/or DM filter component 8′ of power adapter 200 may be reduced as compared to the sizes of the cores of the chokes of CM filter component 6 and/or DM filter component 8 of power adapter 100.

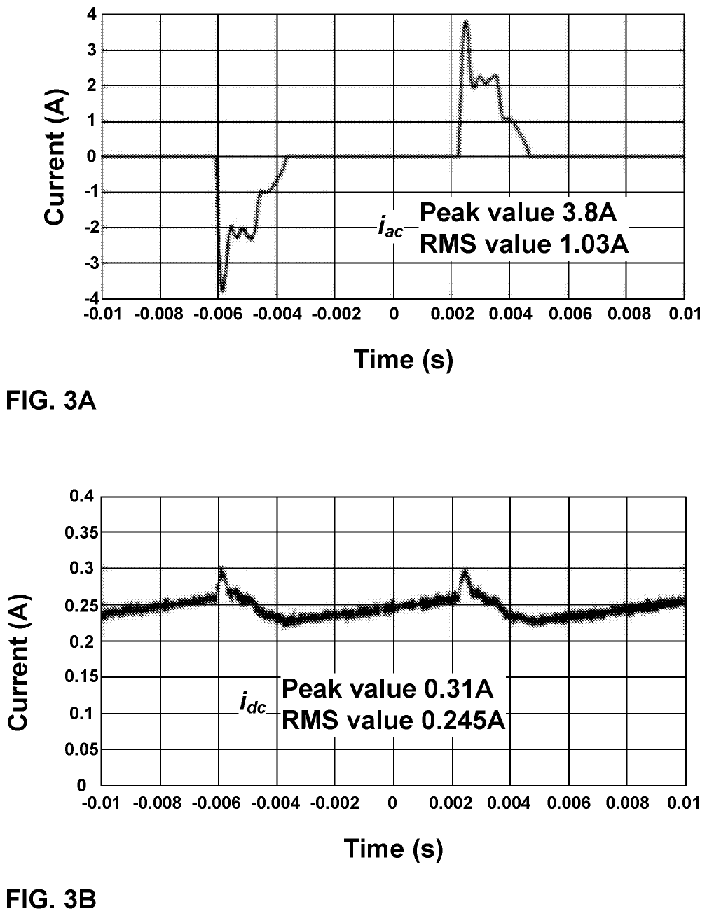

FIGS. 3A and 3B are graphs illustrating currents flowing through power adapters, in accordance with one or more aspects of this disclosure. FIG. 3A illustrates a relationship between current flowing through an AC side of a power adapter, such as the AC side of power adapter 100 of FIG. 1 and annotated as i_{ac}). FIG. 3B illustrates a relationship between current flowing through a DC side of a power adapter, such as the DC side of power adapter 200 of FIG. 2 and annotated as i_{dc}). As can be seen from FIGS. 3A and 3B, the peak value and the RMS value of i_{ac} are both greater than the peak value and the RMS value of i_{dc}.

As discussed above, capacitor 4 of power adapter 100 of FIG. 1 (i.e., the x-capacitor) may be a film capacitor. The use of a film capacitor may be required for capacitors in such positions (i.e., across the line and neutral connectors of an AC connection). However, as capacitor 34 is not in such a position, the requirement for using a film capacitor does not apply. As such, capacitor 34 may be a type of capacitor other than a film capacitor. For instance, capacitor 34 may be a ceramic capacitor. As ceramic capacitors are smaller than film capacitors with equivalent capacitance, utilizing capacitor 34 and omitting capacitor 4 (e.g., as shown in FIG. 2) may enable a reduction in the size of power adapter 200 as compared to power adapter 100.

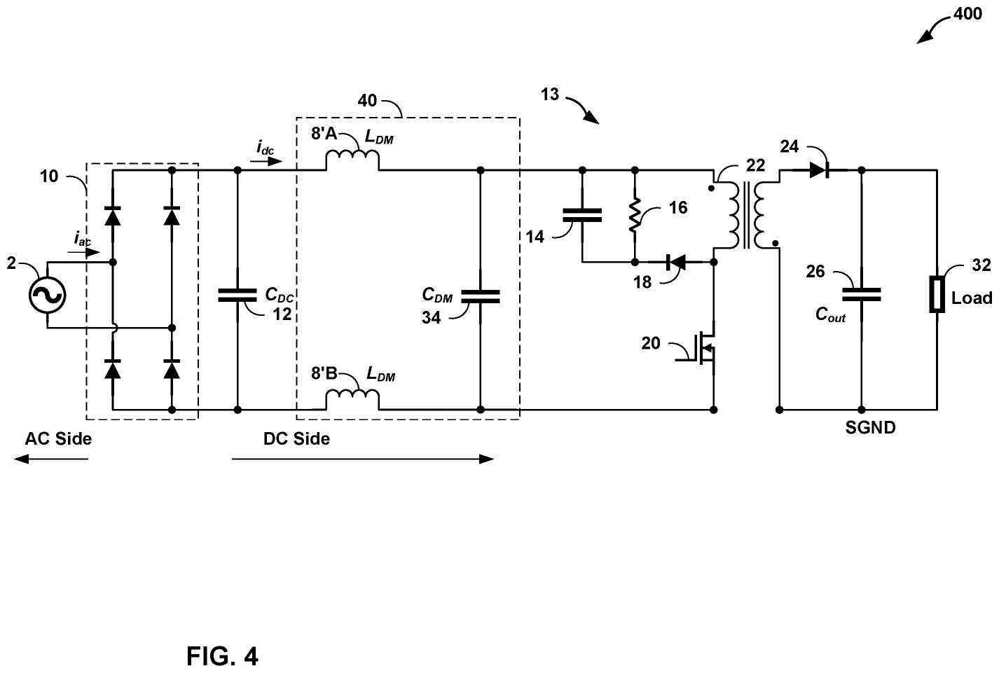

FIG. 4 is a block diagram illustrating a power adapter that includes one or more EMI filter components, in accordance with one or more aspects of this disclosure. AC source 2, rectifier 10, capacitor 12, power converter 13, capacitor 28, and load 32 of power adapter 200 may be configured to perform operations similar to AC source 2, rectifier 10, capacitor 12, power converter 13, capacitor 28, and load 32 of power adapter 100 of FIG. 1.

Similar to power adapter 200 of FIG. 2, power adapter 400 of FIG. 4 includes EMI filter components 40 on a DC side of rectifier 10. However, as opposed to power adapter 200, EMI filter components 40 of power adapter 400 omit a CM choke (e.g., omits CM filter component 6′) and splits DM filter component 8′ into a split DM choke with components 8′A and 8′B. In other words, EMI filter components 40 includes a split DM choke connected to a DC bus, the split DM choke including a first DM choke on a high side of the DC bus (e.g., component 8′A) and a second DM choke on a low side of the DC bus (component 8′B).

Even though power adapter 400 omits a CM choke, DM components 8′A and 8′B may still provide some filtering of common mode noise. As such, DM components 8′A and 8′B may provide both CM and DM noise attenuation capability. For DM noise, DM components 8′A and 8′B may operate as a LC filter with the inductance value equal to 2 L_{DM}. For CM noise, DM components 8′A and 8′B may operate as a CM choke with the inductance value equal to 0.5 L_{DM}. Compared to the topology of power adapter 200, the topology of power adapter 400 may be well suited scenarios where the CM noise is not severe, but the DM noise is dominant (e.g., DM noise is greater than 10 db higher than CM noise). Additionally, by omitting the CM choke, the size of power adapter 400 may be reduced (e.g., as compared to power adapters that include CM chokes).

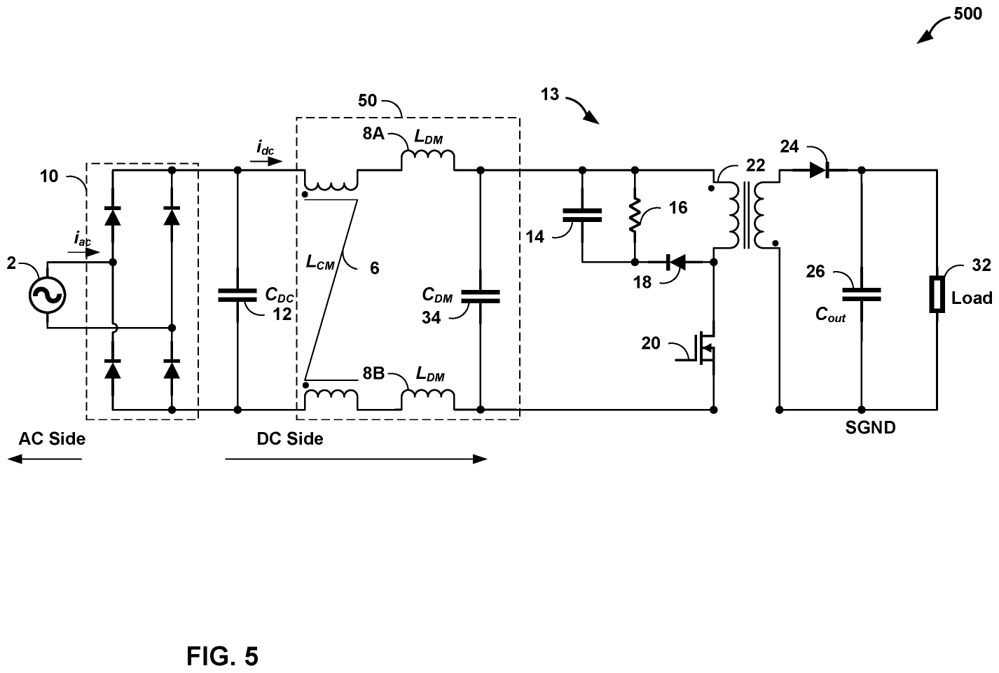

FIG. 5 is a block diagram illustrating a power adapter that includes one or more EMI filter components, in accordance with one or more aspects of this disclosure. AC source 2, rectifier 10, capacitor 12, power converter 13, capacitor 28, and load 32 of power adapter 200 may be configured to perform operations similar to AC source 2, rectifier 10, capacitor 12, power converter 13, capacitor 28, and load 32 of power adapter 100 of FIG. 1. Additionally, DM components 8′A and 8′B of power adapter 500 of FIG. 5 may perform operations similar to DM components 8′A and 8′B may of power adapter 400 of FIG. 4

Similar to power adapter 400 of FIG. 4, power adapter 400 of FIG. 4 includes EMI filter components 50 on a DC side of rectifier 10, including a split DM choke. However, as opposed to EMI filter components 40, EMI filter components 50 includes a CM choke. In other words, EMI filter components 50 includes a CM choke connected to a DC bus (e.g., CM filter component 6′).

EMI filter components 50 may have high noise attenuation capability for CM noise. For instance, including both a CM choke and a split DM choke gives a CM inductance value equal to L_{CM}+0.5 L_{DM}, which provides high noise attenuation capability for CM noise. Compared to the topology of power adapter 200, the topology of power adapter 500 may be well suited to scenarios where the CM noise is very severe.

With real components (e.g., non-ideal component), the high frequency performance of an inductor may be limited due to its parasitic parameters. For instance, an inductor may operate as a capacitor at high frequency and the parasitic capacitances of the inductor can be modeled as an equivalent parallel capacitance (EPC), which is parallel to the inductance L of the inductor. Additionally, the power loss of the inductor can be modeled as an equivalent parallel resistor (EPR), which is also parallel to the inductance L of the inductor. The EPC and EPR of an inductor will bypass the noise current, which may be detrimental to the performance of noise filters, such as EMI filters.

In power adapters, the high frequency CM noise can be severe at high frequencies. In some cases, the high frequency CM noise can even violate EMI standards (e.g., IEC 61000 standards, FCC Part 15, etc.) if not addressed, especially for the adapters with higher switching frequencies. As such, it may be desirable to improve the high frequency CM noise filtration capabilities (e.g., the CM choke performance).

The CM noise filtration capabilities may be improved by canceling out some of the parasitic parameters of the chokes. For instance, by canceling or reducing the EPC of the chokes, the CM noise filtration capabilities (particularly at high frequencies) may be improved.

In accordance with one or more techniques of this disclosure, a power adapter may include one or more cancelation capacitors connected between EMI filter components and a low side of an output of a power converter (e.g., SGND) of the power adapter. For instance, a power adapter may include a capacitor connected between a midpoint of a winding of a CM choke and the low side of the output of the power converter. By including a capacitor as such, the EPC of the CM choke may be canceled. In this way, the techniques of this disclosure may improve CM noise filtration capabilities at higher switching frequencies.

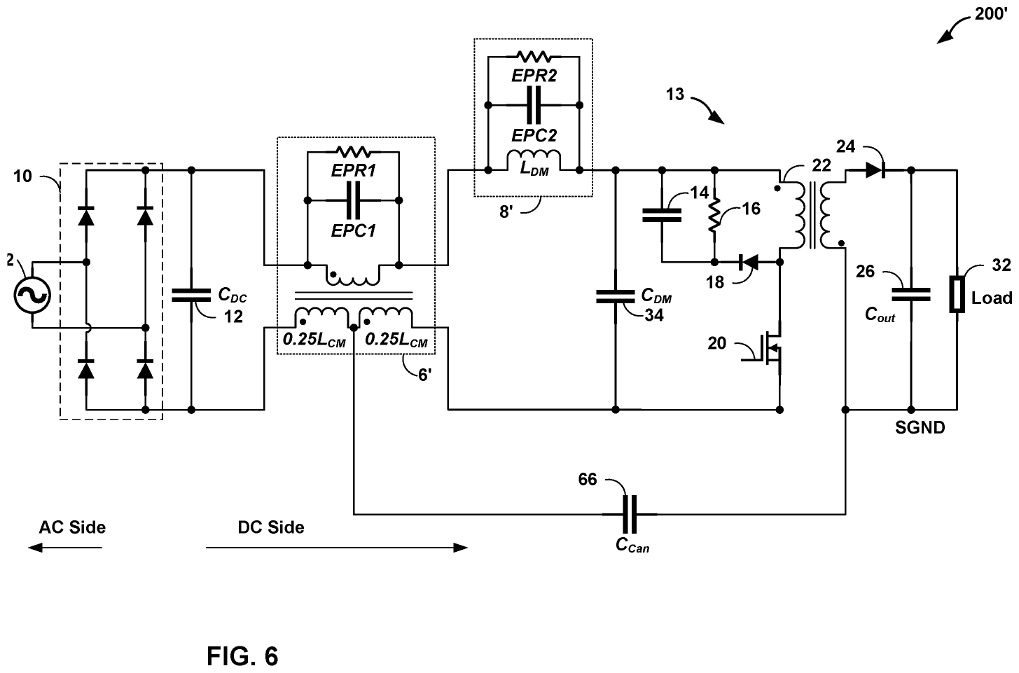

FIGS. 6-8 are block diagrams illustrating example power adapters that includes one or more EMI filter components along with one or more cancelation capacitors, in accordance with one or more aspects of this disclosure. The power adapters of FIGS. 6-8 respectively correspond to the power adapters of FIGS. 2,4, and 5 with the addition of one or more cancelation capacitors and the depiction of EPCs and EPRs.

As shown in FIG. 6, power adapter 200′ includes components similar to power adapter 200 of FIG. 2. As also shown in FIG. 6, the CM choke of CM filter component 6′ is illustrated as including EPR1 and EPC1, and the DM choke of DM filter component 8′ is illustrated as including EPR2 and EPC2. As should be understood, EPR1 and EPC1 represent the equivalent parallel resistance and the equivalent parallel capacitance of the CM choke and are not actually separate circuit elements. Similarly, EPR2 and EPC2 represent the equivalent parallel resistance and the equivalent parallel capacitance of the DM choke and are not actually separate circuit elements. Additionally, the winding of the CM choke of CM filter component 6′ is illustrated as having a tap at a point on the low side, which may be a midpoint.

As discussed above and in accordance with one or more techniques of this disclosure, power adapter 200′ may include cancelation capacitor connected to a midpoint of a low side of the CM choke and a low side of the output DC bus. For instance, as shown in FIG. 6, cancelation capacitor 66 (C_{Can}) may be connected between the tap on the winding of the CM choke of CM filter component 6′ and SGND. The capacitance of the cancelation capacitor may be selected based on the EPC of the CM choke. For instance, a capacitance value of cancellation capacitor 66 may be approximately equal (e.g., within 5%) to four times an equivalent parallel capacitance of the CM choke of CM filter component 6′ (e.g., C_{Can}=4EPC1).

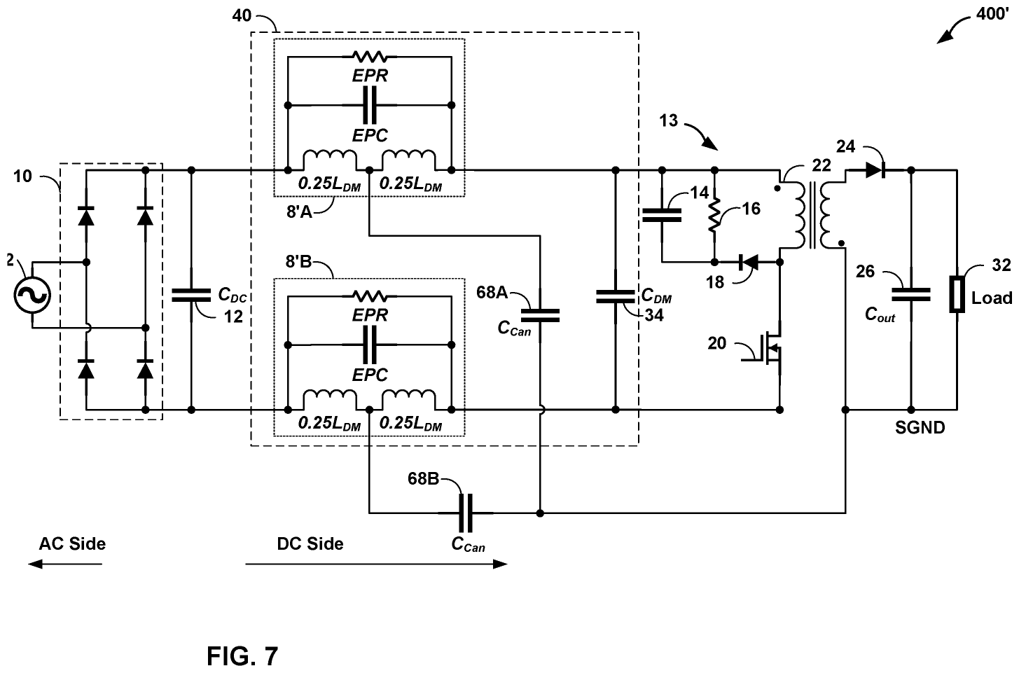

As shown in FIG. 7, power adapter 400′ includes components similar to power adapter 400 of FIG. 4. As also shown in FIG. 7, the DM chokes of DM filter components 8′A and 8′B are illustrated as including EPR and EPC. As should be understood, the EPR and the EPC represent the equivalent parallel resistance and the equivalent parallel capacitance of the DM chokes and are not actually separate circuit elements. Additionally, the winding of the DM chokes of DM filter components 8′A and 8′B are illustrated as having taps at a midpoint.

As discussed above and in accordance with one or more techniques of this disclosure, power adapter 400′ may include a first cancelation capacitor connected to a midpoint of a first DM choke and a low side of the output DC bus, and a second cancelation capacitor connected to a midpoint of a second DM choke and a low side of the output DC bus. For instance, as shown in FIG. 7, first cancelation capacitor 68A (C_{Can}) may be connected between the tap on the winding of the DM choke of DM filter component 8′A and SGND, and second cancelation capacitor 68B (C_{Can}) may be connected between the tap on the winding of the DM choke of DM filter component 8′B and SGND. The capacitance of the cancelation capacitors may be selected based on the EPC of the DM chokes. For instance, a capacitance value of cancellation capacitors 68A and 68B may be approximately equal (e.g., within 5%) to four times an equivalent parallel capacitance of the DM choke of DM filter component 8′A (e.g., C_{Can}=4EPC).

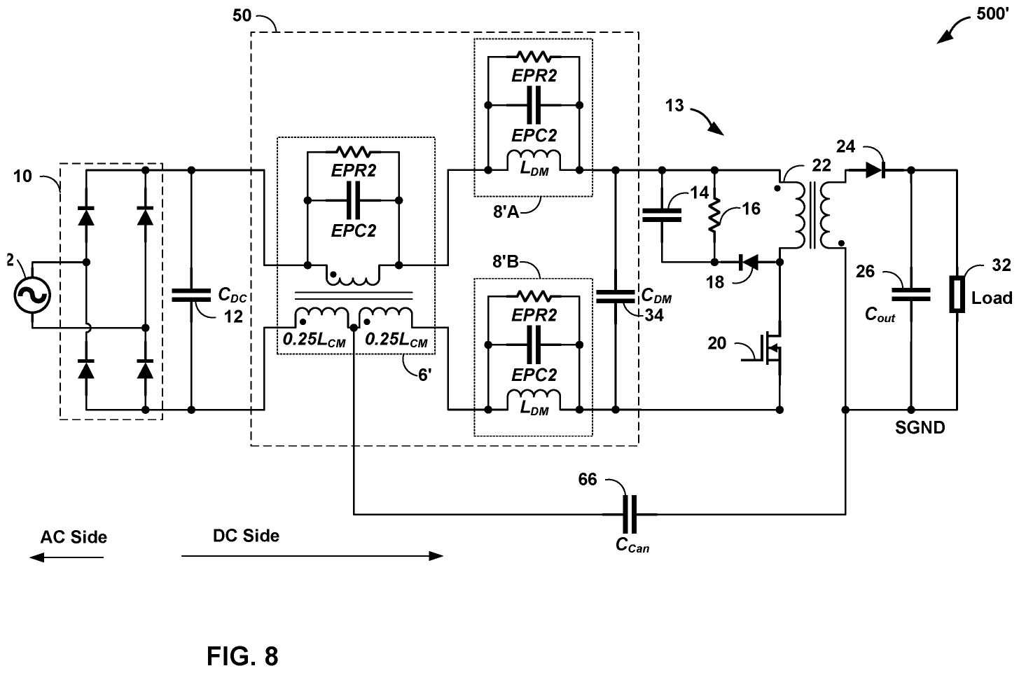

As shown in FIG. 8, power adapter 500′ includes components similar to power adapter 500 of FIG. 5. As discussed above and in accordance with one or more techniques of this disclosure, power adapter 500′ may include cancelation capacitor connected to a midpoint of a low side of the CM choke and a low side of the output DC bus. For instance, as shown in FIG. 8, cancelation capacitor 66 (C_{Can}) may be connected between the tap on the winding of the CM choke of CM filter component 6′ and SGND. The capacitance of the cancelation capacitor may be selected based on the EPC of the CM choke. For instance, a capacitance value of cancellation capacitor 66 may be approximately equal (e.g., within 5%) to four times an equivalent parallel capacitance of the CM choke of CM filter component 6′ (e.g., C_{Can}=4EPC1).

As can be seen in FIGS. 6-8, the EPC cancelation techniques described herein may not require the presence of an earth ground connection. As such, the EPC cancelation techniques described herein can be implemented on power adapters that only have two pins (though they may be equally applicable to power adapters with three pins).

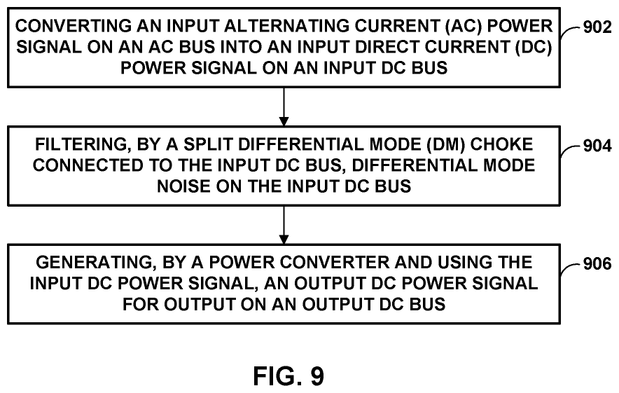

FIG. 9 is a flowchart illustrating example operations of a power adapter, in accordance with one or more aspects of this disclosure. The operations of FIG. 9 may be performed by one or more components of a power adapter, such as power adapter 400 of FIG. 4, power adapter 500 of FIG. 5, power adapter 400′ of FIG. 7, or power adapter 500′ of FIG. 8.

A rectifier of a power converter may convert, an input alternating current (AC) power signal on an AC bus into an input direct current (DC) power signal on an input DC bus (902). For instance, rectifier 10 may convert an input AC power signal received from AC source 2 on an AC side of rectifier 10 into a DC power signal on a DC side of rectifier 10.

As discussed above and in accordance with one or more techniques of this disclosure, one or more EMI filtering components on the DC side of the rectifier may filter differential mode (DM) and/or common mode (CM) noise from the DC power signal. For instance, a split differential mode (DM) choke connected to the input DC bus may filter differential mode noise on the input DC bus (904). In some examples, the split DM choke may include a first DM choke on a high side of the input DC bus (e.g., 8′A) and a second DM choke on a low side of the input DC bus (e.g., 8′B).

A power converter may generate, using the input DC power signal, an output DC power signal for output on an output DC bus (906). For instance, power converter 13 may generate the output DC power signal with a voltage selected for the load (e.g., 5 volts, 9 volts, 20 volts, etc.). The load may be any electronic or computing device. Example loads include, but are not limited to, mobile phones, laptops, tablets, computing sticks, and the like.

In some examples, a power adapter may be integrated into an in-wall receptacle. For instance, a power adapter may be placed in a junction box and include one or more USB connectors and one or more NEMA connectors (e.g., NEMA 5-15 connectors). Where the power adapter is placed in a junction box, the size of the power adapter may be restricted as required to fit within the junction box. By configuring a power adapter in accordance with this disclosure (e.g., with EMI filter components on the DC side of a rectifier), a power adapter integrated into an in-wall receptacle may achieve a greater power output level (e.g., increased from 20 watts to 60 watts).

The following numbered examples may illustrate one or more aspects of the disclosure:

Example 1. A power adapter comprising: a rectifier configured to convert an input alternating current (AC) power signal on an AC bus into an input direct current (DC) power signal on an input DC bus; a split differential mode (DM) choke connected to the input DC bus, wherein the split DM choke comprises a first DM choke on a high side of the input DC bus and a second DM choke on a low side of the input DC bus; and a switched mode power converter configured to output, using the input DC power signal, an output DC power signal on an output DC bus.

Example 2. The power adapter of example 1, further comprising: a first cancellation capacitor connected to a midpoint of the first DM choke and a low side of the output DC bus; and a second cancellation capacitor connected to a midpoint of the second DM choke and a low side of the output DC bus.

Example 3. The power adapter of example 2, wherein a capacitance value of the first cancellation capacitor is approximately equal to four times an equivalent parallel capacitance of the first DM choke, and wherein a capacitance value of the second cancellation capacitor is approximately equal to four times an equivalent parallel capacitance of the second DM choke.

Example 4. The power adapter of example 3, wherein the equivalent parallel capacitance of the first DM choke is approximately equal to the equivalent parallel capacitance of the second DM choke.

Example 5. The power adapter of example 1, further comprising: a common mode (CM) choke connected to the input DC bus.

Example 6. The power adapter of example 5, further comprising: a cancellation capacitor connected to a midpoint of a low side of the CM choke and a low side of the output DC bus.

Example 7. The power adapter of example 6, wherein a capacitance value of the cancellation capacitor is approximately equal to four times an equivalent parallel capacitance of the CM choke.

Example 8. The power adapter of any of examples 1-7, further comprising: a capacitor connected across the high side and the low side of the input DC bus.

Example 9. The power adapter of example 8, wherein the capacitor comprises a ceramic capacitor.

Example 10. The power adapter of example 8, wherein the device does not include an x-capacitor across the AC bus.

Example 11. The power adapter of any of examples 1-10, further comprising: a load connector on the output DC bus.

Example 12. The power adapter of example 11, wherein the load connector comprises a universal serial bus (USB) type-C connector.

Example 13. A method comprising: converting, by a rectifier, an input alternating current (AC) power signal on an AC bus into an input direct current (DC) power signal on an input DC bus; filtering, by a split differential mode (DM) choke connected to the input DC bus, differential mode noise on the input DC bus, wherein the split DM choke comprises a first DM choke on a high side of the input DC bus and a second DM choke on a low side of the input DC bus; generating, by a switched mode power converter and using the input DC power signal, an output DC power signal for output on an output DC bus.

Example 14. The method of example 13, further comprising: canceling, by a first cancellation capacitor connected to a midpoint of the first DM choke and a low side of the output DC bus, an equivalent parasitic capacitance of the first DM choke; and canceling, by a second cancellation capacitor connected to a midpoint of the second DM choke and a low side of the output DC bus, an equivalent parasitic capacitance of the second DM choke.

Example 15. The method of example 14, wherein a capacitance value of the first cancellation capacitor is approximately equal to four times an equivalent parallel capacitance of the first DM choke, and wherein a capacitance value of the second cancellation capacitor is approximately equal to four times an equivalent parallel capacitance of the second DM choke.

Example 16. The method of example 13, further comprising: filtering, by a common mode (CM) choke connected to the input DC bus, common mode noise on the input DC bus.

Example 17. The method of example 16, further comprising: canceling, by a cancellation capacitor connected to a midpoint of a low side of the CM choke and a low side of the output DC bus, an equivalent parasitic capacitance of the CM choke.

Example 18. The method of example 17, wherein a capacitance value of the cancellation capacitor is approximately equal to four times an equivalent parallel capacitance of the CM choke.

Various aspects have been described in this disclosure. These and other aspects are within the scope of the following claims.

1. A power adapter comprising:
a rectifier configured to convert an input alternating current (AC) power signal on an AC bus into an input direct current (DC) power signal on an input DC bus;
a split differential mode (DM) choke connected to the input DC bus, wherein the split DM choke comprises a first DM choke on a high side of the input DC bus and a second DM choke on a low side of the input DC bus; and
a switched mode power converter configured to output, using the input DC power signal, an output DC power signal on an output DC bus.

2. The power adapter of claim 1, further comprising:
a first cancellation capacitor connected to a midpoint of the first DM choke and a low side of the output DC bus; and
a second cancellation capacitor connected to a midpoint of the second DM choke and a low side of the output DC bus.

3. The power adapter of claim 2, wherein a capacitance value of the first cancellation capacitor is approximately equal to four times an equivalent parallel capacitance of the first DM choke, and wherein a capacitance value of the second cancellation capacitor is approximately equal to four times an equivalent parallel capacitance of the second DM choke.

4. The power adapter of claim 3, wherein the equivalent parallel capacitance of the first DM choke is approximately equal to the equivalent parallel capacitance of the second DM choke.

5. The power adapter of claim 1, further comprising:
a common mode (CM) choke connected to the input DC bus.

6. The power adapter of claim 5, further comprising:
a cancellation capacitor connected to a midpoint of a low side of the CM choke and a low side of the output DC bus.

7. The power adapter of claim 6, wherein a capacitance value of the cancellation capacitor is approximately equal to four times an equivalent parallel capacitance of the CM choke.

8. The power adapter of claim 1, further comprising:
a capacitor connected across the high side and the low side of the input DC bus.

9. The power adapter of claim 8, wherein the capacitor comprises a ceramic capacitor.

10. The power adapter of claim 8, wherein the device does not include an x-capacitor across the AC bus.

11. The power adapter of claim 1, further comprising:
a load connector on the output DC bus.

12. The power adapter of claim 11, wherein the load connector comprises a universal serial bus (USB) type-C connector.

13. A method comprising:
converting, by a rectifier, an input alternating current (AC) power signal on an AC bus into an input direct current (DC) power signal on an input DC bus;
filtering, by a split differential mode (DM) choke connected to the input DC bus, differential mode noise on the input DC bus, wherein the split DM choke comprises a first DM choke on a high side of the input DC bus and a second DM choke on a low side of the input DC bus; and
generating, by a switched mode power converter and using the input DC power signal, an output DC power signal for output on an output DC bus.

14. The method of claim 13, further comprising:
canceling, by a first cancellation capacitor connected to a midpoint of the first DM choke and a low side of the output DC bus, an equivalent parasitic capacitance of the first DM choke; and
canceling, by a second cancellation capacitor connected to a midpoint of the second DM choke and a low side of the output DC bus, an equivalent parasitic capacitance of the second DM choke.

15. The method of claim 14, wherein a capacitance value of the first cancellation capacitor is approximately equal to four times an equivalent parallel capacitance of the first DM choke, and wherein a capacitance value of the second cancellation capacitor is approximately equal to four times an equivalent parallel capacitance of the second DM choke.

16. The method of claim 13, further comprising:
filtering, by a common mode (CM) choke connected to the input DC bus, common mode noise on the input DC bus.

17. The method of claim 16, further comprising:
canceling, by a cancellation capacitor connected to a midpoint of a low side of the CM choke and a low side of the output DC bus, an equivalent parasitic capacitance of the CM choke.

18. The method of claim 17, wherein a capacitance value of the cancellation capacitor is approximately equal to four times an equivalent parallel capacitance of the CM choke.

19. A system comprising:
a power adapter comprising:
a rectifier configured to convert an input alternating current (AC) power signal on an AC bus into an input direct current (DC) power signal on an input DC bus;
a split differential mode (DM) choke connected to the input DC bus, wherein the split DM choke comprises a first DM choke on a high side of the input DC bus and a second DM choke on a low side of the input DC bus; and
a switched mode power converter configured to output, using the input DC power signal, an output DC power signal on an output DC bus; and
a computing device configured to receive the output DC power signal via the output DC bus.

20. The system of claim 19, further comprising one or more cancelation capacitors.
